(19) United States
(12) Patent Application Publication
(10) Pub. No.: US 2017/0258124 A1
(43) Pub. Date: Sep. 14, 2017

(54) METHOD FOR FULFILLING THE NUTRITIONAL NEEDS OF INDIVIDUALS WITH DIETARY RESTRICTIONS THROUGH PRE-PACKAGED ENTREES IN COMPLIANCE WITH USDA REGULATIONS

(71) Applicant: Stephen L. PITZER, Peterstown, WV (US)

(72) Inventor: Stephen L. PITZER, Peterstown, WV (US)

(21) Appl. No.: 15/064,117

(22) Filed: Mar. 8, 2016

(51) Int. Cl. A23L 33/00; A23L 23/00

(52) U.S. Cl. CPC A23L 33/30; A23L 23/00; A23V 2002/00

(57) ABSTRACT

A method for fulfilling the nutritional needs of a targeted group through prepackaged entrees that comply with USDA regulations is provided. The prepackaged entrees are designed to provide a plurality of nutritional parameters associated with the targeted group, wherein a foodstuff is adapted to provide a first portion of the plurality of nutritional parameters, and wherein a separate nutritional sauce is adapted to provide a second portion of the plurality of nutritional parameters. The nutritional sauce being physically separated from the foodstuff within the same prepackaged entrée so as to comply with governing USDA regulations.

### BACKGROUND OF THE INVENTION

The present invention relates to diet systems and, more particularly, to a method for fulfilling the nutritional needs of individuals with dietary restrictions through pre-packaged entrees, while complying with USDA regulations.

An individual with dietary restrictions, like everybody else, has the need and desire for the convenience of a pre-packaged meal. There are some dietary restrictions, however, that prohibit individuals from purchasing and consuming existing pre-packaged meals due to the lack of critical nutrients or the presence of un-wanted or un-healthy nutrients therein, as current re-packaged entrees do not provide the proper nutrition for many dietary restrictions.

A big reason for this is that United Stated Department of Agriculture (USDA) regulations do not permit the fortification of pre-packaged entrees to improve the nutritional value. As a result, current pre-packaged entrees are manufactured for the general public and contain only basic nutrients not significant enough to be beneficial for specified consumer groups with increased nutritional needs. These other entrees may also contain nutrients or ingredients which pose as a health risk to specific consumer groups.

As can be seen, there is a need for a method for fulfilling the nutritional needs of individuals with dietary restrictions through pre-packaged entrees, while complying with USDA regulations, whereby pre-packaged entrees are engineered specifically for selected consumer groups, increasing the critical nutrients while eliminating or reducing the unwanted nutrients for the targeted consumer group.

### SUMMARY OF THE INVENTION

In one aspect of the present invention, a method for fulfilling the nutritional needs of a group with dietary restrictions through prepackaged entrees that comply with USDA regulations includes: identifying at least one dietary restriction;

establishing a plurality of nutritional parameters for each identified dietary restriction, wherein the plurality of nutritional parameters includes a first portion and a second portion of the plurality of nutritional parameters; selecting at least one raw ingredient including the first portion of the plurality of nutritional parameters; developing a complimentary nutrient sauce adapted for enhancing the taste or appearance of the at least one raw ingredient; adding a nutritional deficiency to the complimentary nutrient sauce, wherein the nutritional deficiency includes at least the second portion of the plurality of nutritional parameters; providing a prepackage container; and retaining the at least one raw ingredient in the prepackage container along with the complimentary nutrient sauce, wherein the complimentary nutrient sauce is separated from the at least one raw ingredient, thereby complying with USDA regulations.

In another aspect of the present invention, the method may include the at least one raw ingredient providing a USDA regulated meal.

In another aspect of the present invention, the method may include the step of determining a nutritional deficiency between the plurality of nutritional parameters and a combination of the complimentary nutrient sauce and the at least one raw ingredient.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a pre-packaged entrée of the present invention;

FIG. 2 is an exploded view of an exemplary embodiment of the present invention;

FIG. 3 is a section view of an exemplary embodiment of the present invention, taken along line 3-3 of FIG. 1;

FIG. 4 is a flow chart of an exemplary embodiment of the present invention;

FIG. 5 is a flow chart of an exemplary embodiment of the present invention; and

FIG. 6 is a continuation of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for fulfilling the nutritional needs of a targeted group through prepackaged entrees that comply with USDA regulations. The prepackaged entrees are designed to provide a plurality of nutritional parameters associated with the targeted group, wherein a foodstuff is adapted to provide a first portion of the plurality of nutritional parameters, and wherein a separate nutritional sauce is adapted to provide a second portion of the plurality of nutritional parameters. The nutritional sauce being physically separated from the foodstuff within the same prepackaged entrée so as to comply with governing USDA regulations.

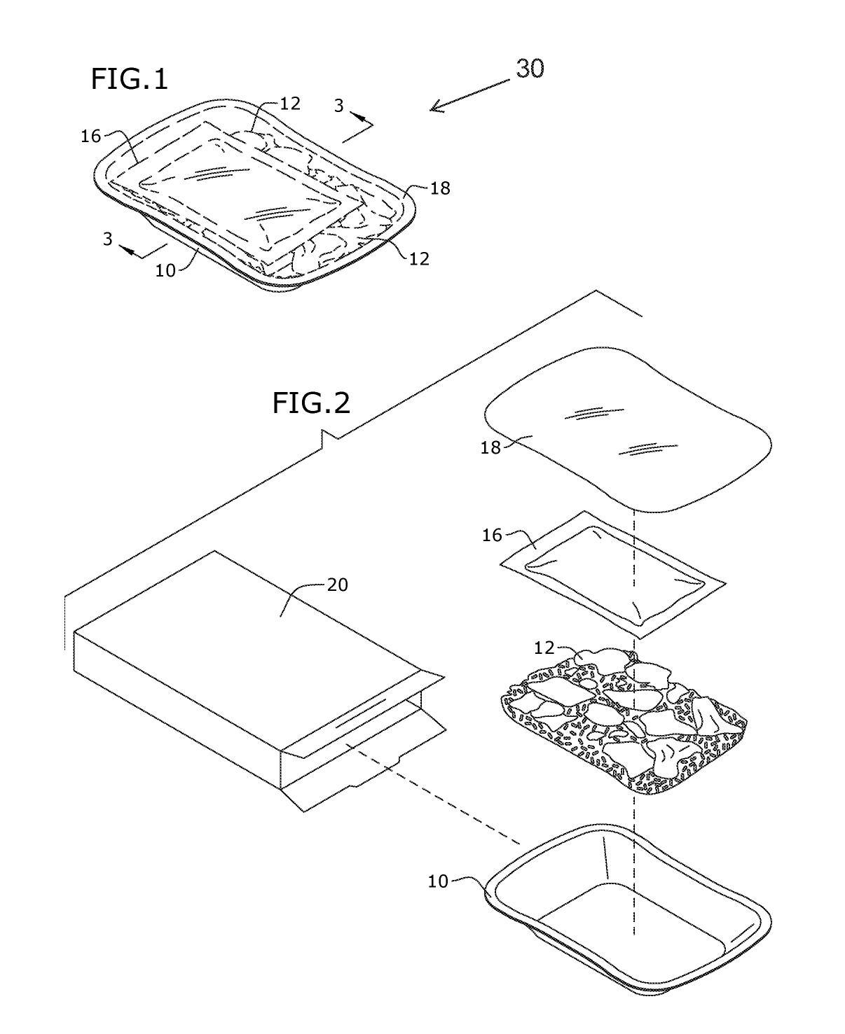

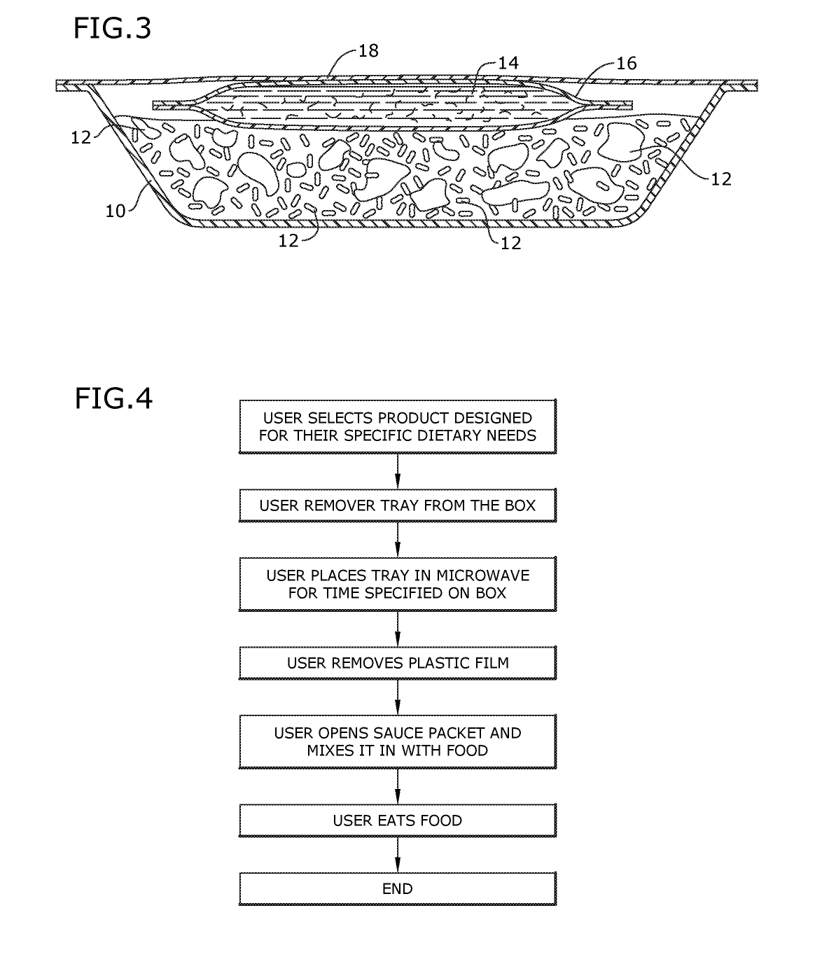

Referring to FIGS. 1 through 3, the present invention may include a plurality of pre-packaged entrees 30, each providing at least one container 10 having an open-faced cavity dimensioned and adapted to retain foodstuff 12. Each container 10 may include at least one regulation packet 16, each regulation packet 16 retaining a hermetically sealed nutrient sauce 14. A sealing film 18 dimensioned and adapted to hermetically seal to a container 10 along a periphery of the open-face, sealing the foodstuff 12 and at least one regulation packet 16 within the cavity. The present invention may include a delivery container 20 dimensioned and adapted to receive and retain at least one container 10.

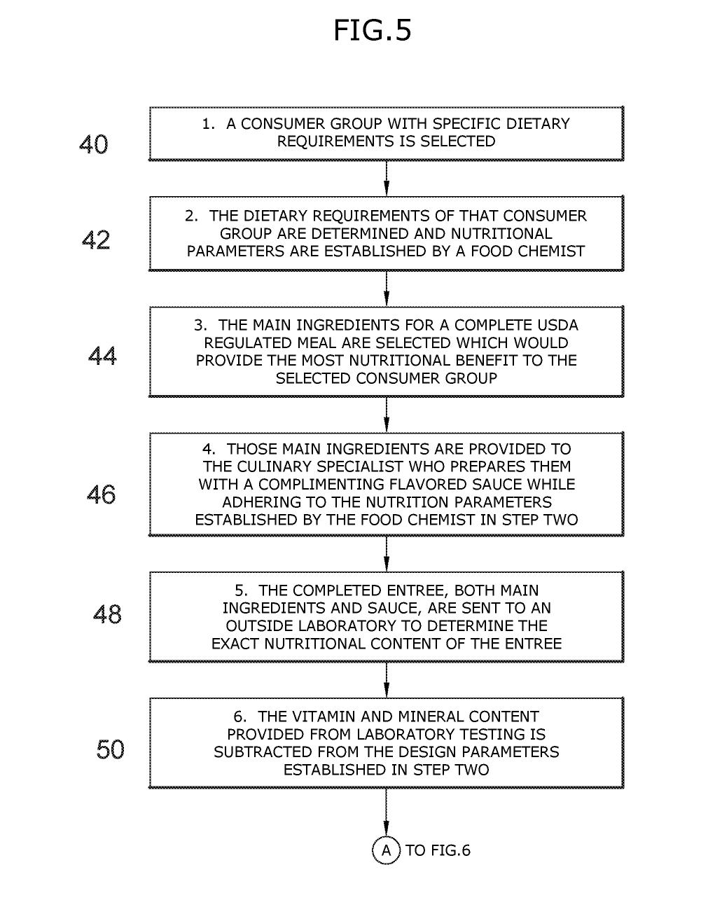

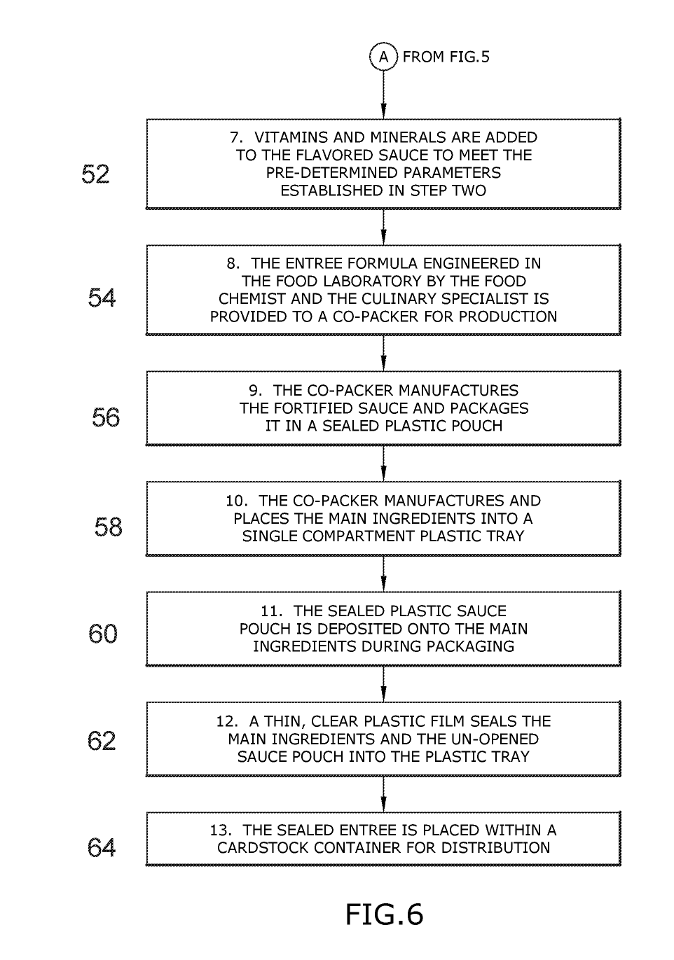

Referring to FIGS. 4 through 6, the present invention is engineered to enhance the specific nutritional requirements of a targeted consumer groups by establishing nutritional parameters for each pre-packaged entree 30. Raw ingredients, main ingredients and other foodstuff 12 are selected according to those parameters and the nutrient sauce 14 is fortified with the specific vitamins and minerals needed to boost or add those critical nutrients deemed significant to the well-being of that specific consumer group while reducing or eliminating un-healthy or harmful substances.

The regulation packet 16 containing the nutrient sauce 14 is placed un-opened within the pre-packaged entree 30 during the manufacturing process. On the regulation packet and/or pre-packaged entree 30 may be instructions for opening the regulation packet 16 and adding the nutrient sauce 14 to the foodstuff 12 by a user—i.e., during preparation for consumption—thereby complying with regulations previously prohibiting vitamin or mineral fortification of a USDA regulated meal.

The nutrient sauce 14 can be flavored to compliment nearly any raw ingredients/foodstuff 12 so to provide critical nutrition, great taste and convenience. Furthermore, each regulation packet 16 is adapted to seal the nutrient sauce 14 therein so that the nutrient sauce 14 is not in contact with the foodstuff 12, complying with USDA regulation regarding vitamin and mineral fortification for pre-packaged meals/foodstuff 12. Thereby the pre-packaged entrée 30 complies with USDA regulations, as the fortification of the nutritional benefits is providing through user preparation prior to consumption.

A method of using the present invention may include the following. The pre-packaged entrée 30 disclosed above may be provided. During step 40, at least one consumer group with dietary restrictions is selected. In step 42, a food chemist establishes a plurality of nutritional parameters for each selected consumer group based on available medical research. The plurality of nutritional parameters may include a first portion and a second portion thereof. plurality of nutritional parameters may include amounts of specific vitamins, minerals, amino acids, electrolytes, and the like. In step 44, the food chemist designs a complete meal by determining raw ingredients/foodstuff 12 which are nutritionally beneficial to the established plurality of nutritional parameters, thereby forming the first portion thereof, wherein the determined raw ingredients/foodstuff 12 are sufficient for a complete USDA regulated meal.

In step 46, a food laboratory and/or culinary specialist develops a complimentary nutrient sauce 14 for enhancing the combined taste and appearance of the nutrient sauce 14 and the foodstuff 12, wherein the nutrient sauce 14 is adapted to be fortified with specific vitamins, minerals, amino acids, electrolytes, and the like needed to boost or add those critical nutrients forming the second portion of the plurality of nutritional parameters established by the food chemist.

In step 48, the combination of the determined raw ingredients/foodstuff 12 and the complimentary nutrient sauce 14 is tested by an outside laboratory to determine the exact nutritional contents thereof.

In step 50, utilizing these lab test results, the food chemist determines the additional amount of vitamin and mineral fortification to be added to the complimentary nutrient sauce 14—the second portion of the plurality of nutritional parameters—by subtracting the values in the lab results from the established target parameters for that consumer group in step 42.

In step 52, the additional amount of vitamin and mineral fortification of the second portion of the plurality of nutritional parameters is added to the complimentary nutrient sauce 14 by the manufacturer.

In steps 54 and 56, the fortified final nutrient sauce 14 is packaged in the regulation packet 16.

In step 58, the main ingredients/foodstuff 12 may be deposited into a single compartment container 10 and then, in step 60, the at least one final nutrient sauce 14-filled regulation packet 16 is deposited onto the main ingredients/foodstuff 12 during manufacturing.

In step 62 the sealing film 18 may be applied to the top of the single compartment tray container 10, sealing and protecting both the main ingredients/foodstuff 12 and the un-opened regulation packet 16.

In step 64, the completed pre-packaged entrée 30 is placed within a delivery container 20 for distribution.

In alternative embodiments, the final nutrient sauce 14 can be formulated in a wide variety of flavors and nutritional content to fulfill the dietary needs of different consumer groups such as diabetics, athletes, pregnant and lactating women, anemia, cancer patients, nursing homes, hospital facilities, schools with children with specific dietary requirements or those with food allergies, the military and other groups.

It should be understood, of course, that the foregoing relates to exemplary embodiments of the invention and that modifications may be made without departing from the spirit and scope of the invention as set forth in the following claims.

What is claimed is:

1. A method for fulfilling the nutritional needs of a group with dietary restrictions through prepackaged entrees that comply with USDA regulations, comprising the steps of:
identifying at least one dietary restriction;
establishing a plurality of nutritional parameters for each identified dietary restriction, wherein the plurality of nutritional parameters includes a first portion and a second portion of the plurality of nutritional parameters;
selecting at least one raw ingredient including the first portion of the plurality of nutritional parameters;
developing a complimentary nutrient sauce adapted for enhancing the taste or appearance of the at least one raw ingredient;
adding a nutritional deficiency to the complimentary nutrient sauce, wherein the nutritional deficiency includes at least the second portion of the plurality of nutritional parameters;
providing a prepackage container; and
retaining the at least one raw ingredient in the prepackage container along with the complimentary nutrient sauce, wherein the complimentary nutrient sauce is separated from the at least one raw ingredient, thereby complying with USDA regulations.

2. The method of claim 1, wherein the nutritional deficiency comprises vitamins and minerals.

3. The method of claim 1, wherein the at least one raw ingredient comprises a USDA regulated meal.

4. The method of claim 3, further comprising the step of determining a nutritional deficiency between the plurality of nutritional parameters and a combination of the complimentary nutrient sauce and the at least one raw ingredient.

5. The method of claim 1, wherein the complimentary nutrient sauce is separated from the at least one raw ingredient by a regulation packet.

6. The method of claim 5, further comprising providing a sealing film to seal the regulation packet and the at least one raw ingredient within the prepackage container.

7. The method of claim 6, wherein the sealed prepackaged container of the regulation packet and the at least one raw ingredient comprises a prepackaged entrée.

8. The method of claim 7, wherein the prepackaged entrée is USDA compliant.

9. The method of claim 8, wherein the prepackaged entrée is placed within a delivery container for distribution.
